(19) United States
(12) Patent Application Publication
(10) Pub. No.: US 2005/0110660 A1
(43) Pub. Date: May 26, 2005

(54) Traffic control malfunction management unit with flashing don't walk monitoring

(75) Inventor: Allen Jacobs, Reno, NV (US)

Correspondence Address: Warren P. Kujawa, 1770 N. Green Valley Pkwy., Unit 3833, Henderson, NV, 89074, US

(73) Assignee: RENO AGRICULTURE AND ELECTRONICS, Reno, NV (US)

(21) Appl. No.: 10/719,314

(22) Filed: Nov. 20, 2003

(51) Int. Cl. G08G 1/095

(52) U.S. Cl. 340/944; 340/907; 340/931

(57) ABSTRACT

A malfunction management method and apparatus for monitoring for conflicts between pedestrian advisory sign control signals and vehicle Ian signal head control signals generated by a traffic control unit. Continuously activated (solid) control signals for pedestrian advisory signs and vehicle lane signal heads are monitored for conflicts between WALK pedestrian signals and GREEN and YELLOW vehicle signals for vehicle lanes potentially conflicting with the pedestrian walk way. Flashing DON'T WALK pedestrian signals and continuously activated Green and YELLOW vehicle signals for potentially conflicting vehicle lanes are also monitored for conflicts. A display indicates which input signal channels are enabled for monitoring in the flashing DON'T WALK mode.

### BACKGROUND OF THE INVENTION

This invention relates to traffic control equipment used to monitor the states of traffic signal head control signals for conflicts. More particularly, this invention relates to a malfunction management unit which monitors for conflicts between traffic signal head control signals and pedestrian advisory sign control signals. Traffic signal heads and pedestrian advisory signs are commonly used to regulate the flow of vehicular and pedestrian traffic. A typical traffic signal head is provided with red, yellow, and green A.C. operated light sources, while a typical pedestrian advisory sign has A.C. operated “WALK” and DON'T WALK” light sources. For safety reasons, the traffic control industry has long used equipment to monitor the states of the electrical power signals used to operate the traffic signal head light sources and the pedestrian advisory sign light sources for conflicts. Under the TS-1 standard, this equipment is called a conflict management unit (CMU); under the later TS-2 standard, this equipment is called a malfunction management unit (MMU). If the electrical power signals for the RED and GREEN light sources of a particular lane controlled by a traffic signal head are simultaneously active, for example, this represents a dangerous traffic control signal condition for the associated lane, since the motorist is observing the conflicting signal conditions of STOP and GO. Similarly, if the electrical power signals for the WALK and DON'T WALK light sources of a particular cross walk controlled by a pedestrian advisory sign are simultaneously active, this represents a dangerous pedestrian control signal condition for the associated cross walk since the pedestrian is observing the conflicting signal conditions of WALK and DON'T WALK.

In addition to monitoring for conflicts between control signals for the light sources of the same lane or same cross walk, known conflict monitors also monitor the control signals for the light sources of multiple lanes and cross walks for dangerous conflicts. For example, if the electrical power signals for the GREEN light sources of intersecting lanes controlled by a signal head are simultaneously activated, this represents a dangerous traffic control signal condition for both lanes since motorists approaching the intersection along the intersecting lanes both observe the GO signal condition. Similarly, if the electrical power signal for the GREEN light source of a vehicular lane is simultaneously activated with the electrical power signal for the WALK light source of a cross walk intersecting the vehicular lane, both the motorist and the pedestrian observe signal conditions indicating that both are free to proceed.

There are many other examples of signal conflicts which are monitored by existing conflict monitors. In all cases, the conflict monitor responds to signal conflicts by overriding the operation of the intersection traffic control unit and taking control of the operation of the traffic signal head. A common method is to place the traffic signal light sources in a flashing mode of operation by switching the states of dedicated electrical relays. These dedicated relays remain in this flashing mode until the source of the conflict problem is diagnosed and fixed.

In the past, when monitoring for conflicts between pedestrian cross walk signal heads and traffic signal heads having traffic control light sources for vehicle lanes which intersect the pedestrian cross walk, known conflict monitors have only monitored the various control signals for conflicts between solid (continuously activated) WALK or DON'T WALK pedestrian signals and the signals controlling the RED, YELLOW, and GREEN traffic light control signals for the intersecting vehicular lane. This configuration guarantees that the simultaneous activation of the WALK pedestrian signal and the GREEN vehicle signal for the intersecting vehicle lane is perceived as an impermissible conflict. However, this configuration allows a potentially dangerous set of conflicting signal conditions. In particular, it is common for pedestrian signal heads to employ a flashing DON'T WALK phase to signal pedestrians that sufficient time remains for the average person to step off the curb and safely walk to the other side of the cross walk. In known conflict monitors, the flashing DON'T WALK signal phase is accorded no status. Consequently, with current conflict monitors simultaneous activation of a flashing DON'T WALK pedestrian signal and a GREEN vehicle signal for the intersecting vehicle lane is not perceived as a conflict and no action is taken by the conflict monitor, even though the condition of the two signals is potentially dangerous. Stated differently, existing conflict monitors do not prevent a pedestrian from proceeding along a cross walk while the traffic signal in the intersecting vehicle lane is GREEN. The invention is directed to the elimination of this inadequacy in known conflict monitors.

### SUMMARY OF THE INVENTION

The invention comprises a malfunction management unit for traffic signal control equipment which monitors for a conflict between a solid WALK pedestrian control signal and a solid GREEN vehicle control signal for an intersecting lane, and also monitors for a conflict between a flashing DON'T WALK pedestrian control signal and a solid GREEN vehicle control signal for an intersecting lane.

From an apparatus standpoint, the invention comprises a malfunction management unit for a traffic control unit for monitoring for conflicts between pedestrian control signals and potentially conflicting vehicle control signals, the unit comprising a processor having a plurality of A.C. signal input terminals for receiving control signals used to operate the traffic control lights and pedestrian advisory signs, monitoring means for detecting a conflict between a flashing DON'T WALK input signal and other traffic control signals; and an output for controlling the operation of an output relay used to transfer the operation of the traffic control lights to a flashing mode of operation when a conflict is detected.

The malfunction management unit includes a manually settable switch for enabling and disabling the monitoring means and a display for indicating whether the monitoring means is enabled in the flashing DON'T WALK mode of operation.

Control signals are typically assigned to channels, and the display includes a plurality of display units assigned to different channels to indicate those channels for which the monitoring means is enabled in the flashing DON'T WALK mode of operation.

From a process standpoint, the invention comprises a method of monitoring for conflicts between flashing DON'T WALK pedestrian advisory sign control signals and other control signals used to operate traffic control lights, the method comprising the steps of;
(a) detecting a flashing DON'T WALK pedestrian advisory sign control signal;
(b) detecting the states of the other control signals; and
(c) generating a fault signal when a conflict occurs between a flashing DON'T WALK signal and the other control signals.
   The pedestrian advisory sign control signals and the other control signals are grouped in a plurality of channels; and the method further includes the step of providing a display of those channels on which steps (a) and (b) are enabled. The method further includes the step of manually enabling the performance of steps (a) and (b).

The invention provides enhanced safety to a traffic control system by eliminating the inherent danger of an undetected conflict between a flashing DON'T WALK pedestrian advisory signal and a conflicting GREEN or YELLOW vehicle control signal.

For a fuller understanding of the nature and advantages of the invention, reference should be had to the ensuing detailed description taken in conjunction with the accompanying drawings.

### BRIEF DESCRIPTION OF THE DRAWINGS

FIG. 1 is a block diagram of a malfunction management unit incorporating the invention;

FIG. 2 is a view of the front panel of the malfunctin management unit of FIG. 1 showing the settable switches and displays incorporated into the preferred embodiment of the invention.

### DETAILED DESCRIPTION OF THE PREFERRED EMBODIMENTS

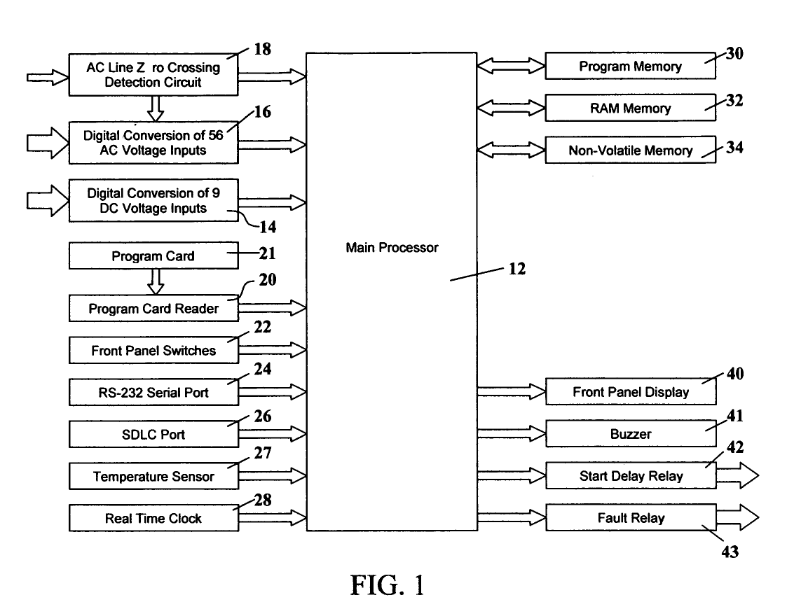

Turning now to the drawings, FIG. 1 is a block diagram of a malfunction management unit incorporating the invention. As seen in this FIG., the malfunction management unit (MMU) includes a main processor 12, preferably an AMD Am186CH40 16-bit microprocessor, and nine microcontrollers. One of these microcontrollers designated with reference numeral 14 is used for digital conversion of nine D.C. voltage inputs from the several D.C. voltage sources used in the associated traffic control system. This microcontroller is preferably an Atmel AT90LS8535 device. Seven of the microcontrollers collectively designated with reference numeral 16 are used for digital conversion of fifty six A.C. voltage inputs from the traffic control unit, with each microcontroller handling eight A.C. voltage inputs. An A.C. line zero crossing unit 18 provides zero crossing information to main processor 12. A program card reader 20 provides programming information relating to configuration parameters read from a programming card 21 described in detail below. A plurality of settable switches 22 mounted on th front panel of the MMU housing enable operator selection of several different functions for individual channels as described more fully below. An RS-232 serial port 24 enables communications between the MMU and a laptop computer for local communications and a modem for remote communications. An SDLC port 26 enables communications with the traffic controller. A temperature sensor 27 is provided to monitor the temperature inside the cabinet housing the MMU and the traffic controller. A real time clock 28 provides a real time reference for the main processor.

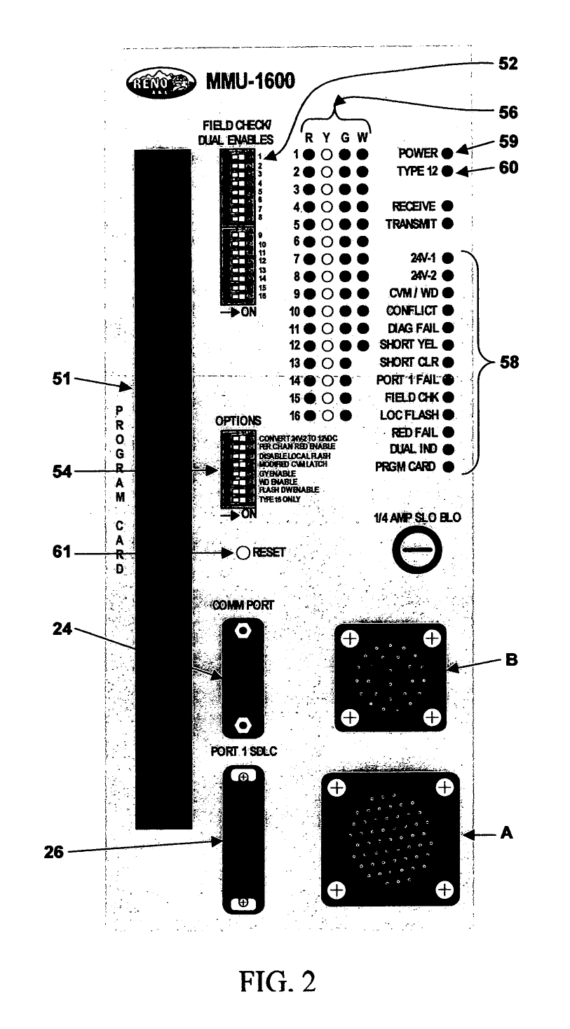

The main processor 12 is coupled to a program memory unit 30, RAM memory unit 32 and non-volatile memory unit 34. The purpose of each of these memory units is described more fully below. Main processor is also coupled to a front panel display 40 shown in FIG. 2; an audible buzzer 41; a start delay relay 42; and a fault relay 43. The structure and function of units 4043 are described more fully below.

FIG. 2 illustrates the front panel of the MMU. As seen in this FIG., a program card slot 51 enables a user to insert and remove programming card 21. Sixteen two position switches 52 enable operator selection of the Field Check/Dual Enable functions described more fully below on a per channel basis. Eight two position switches 54 enable operator selection of different options. These options are termed “Convert 24 V-2 to 12 VDC”; “Per Channel Red Enable”; “Disable Local Flash”; “Modified CVM Latch”; “GY Monitoring Enable”; “Watchdog Enable”; “Flash DW Enable”; and “Type 16 Only” and are individually described in detail below.

A first display group 56 comprising sixty LED indicators provides field status indications for the various Red, Yellow, Green and Walk field inputs. A second display group 58 provides fault information relating to the status of specific fault conditions and whether the particular fault test is enabled or disabled. A pair of connectors (A and B) provide electrical connections for the various input signals described above with reference to FIG. 1.

A Power LED 59 indicates whether power is being applied to the MMU; while a Type 12 LED 60 indicates whether the user has selected Type 12, Type 16, or Type 16 only modes of operation, described below. Lastly, a Reset button switch 61 enables a technician to attempt manual reset of faults recorded by the MMU. Pushing this button also turns on all display LEDs for a period of time sufficient to visually determine if all LEDs are operational.

### Flashing Don't Walk Monitoring

The present invention is directed to the Flashing Don't Walk Monitoring incorporated into the MMU described her in. When this function is enabled, a flashing DON'T Walk control signal is accorded the same testing priority as a YELLOW or GREEN control signal for right-of-way conflicts. Consequently, a conflict between a flashing DON'T WALK and a GREEN or YELLOW conflicting right of way control signal will result in a fault condition for the intersection. This feature is useful when the user wants to ensure that flashing DON'T WALK displays do not conflict with other GREENs, YELLOWs, or WALKs at an intersection. This feature is made active by using the MMU software to specify the channels for which the feature is enabled. The factory default for this feature is no channels enabled.

To enable this feature, the FLASH DW ENABLE option switch in switch group 54 is set to the ON state by the user. When enabled for a channel, the flashing DON'T WALK function monitors the channel RED input for a flashing condition. In the preferred embodiment, a flashing condition is defined as the RED signal remaining in a state for at least 200 milliseconds but no longer than 600 milliseconds. If the RED input signal stays in a state longer than 600 milliseconds, it is no longer considered as flashing. When flashing DON'T WALK monitoring is enabled for a channel, a flashing RED input is checked for conflicts in the same manner as the GREEN, WALK, and YELLOW inputs for that channel, with the difference that a flashing DON'T WALK conflict must persist for 1500 milliseconds to be detected as a fault. This minimum time period allows the MMU sufficient time to detect transitions from the flashing state to the solid ON state and not falsely trip.

When a fault is detected during flashing DON'T WALK monitoring, it is displayed as a conflict by the FAULT LED in display group 58 and the channel with the flashing RED input that was involved in the detected fault will be flashing its RED LED in display group 56. Without this feature enabled, a RED input cannot be part of a conflict fault.

The channels that can be enabled for the flashing DON'T WALK function, when this function is set by the option switch for the MMU, can be observed from the display group 56. This is done by the following steps:
1. Press and hold the RESET switch 61.
2. Move the option switch labeled FLASH DW ENABLE to the OFF position if not already there.
3. Move the option switch labeled FLASH DW ENABLE to the ON position
4. The RED channel LEDs will now display an ON condition for channels with this feature enabled.
5. Release the RESET switch 61 and the MMU display will return to normal operation.
6. Set the option switch labeled FLASH DW ENABLE to the desired position.
   During the above display operation, the MMU will continue to operate normally while in this special display mode. Any fault detected while in this mode will be displayed correctly when the RESET switch 61 is released.

As will now be apparent to those skilled in the art, malfunction management units provided with the flashing DON'T WALK monitoring feature avoids the is undesired conflict between a flashing DON'T WALK signal and YELLOWs, GREENs, and WALKs at an intersection. Consequently, this feature enhances pedestrian safety and is thus highly desirable in a system for testing proper assignment of right-of-way for vehicles and pedestrians.

A complete description of the MMU comprising the preferred embodiment of the invention is attached hereto as Appendix A and forms an integral part of this disclosure.

Although the above provides a full and complete disclosure of the preferred embodiments of the invention, various modifications, alternate constructions and equivalents will occur to those skilled in the art. For example, although specific microprocessors and microcontrollers have been identified for the preferred embodiment, other such devices may be employed in the implementation of the invention. Therefore, the above should not be construed as limiting the invention, which is defined by the appended claims.

1. In a traffic control system for coordinated operation of a plurality of traffic control lights and pedestrian advisory signs having potentially conflicting states; a malfunction management unit having input terminals for receiving control signals used to operate the traffic control lights and pedestrian advisory signs, monitoring means for detecting a conflict between a flashing DON'T WALK input signal and other traffic control signals; and an output for controlling the operation of an output relay used to transfer the operation of the traffic control lights to a flashing mode of operation when a conflict is detected.

2. The invention of claim 1 wherein said malfunction management unit includes a manually settable switch for enabling and disabling said monitoring means.

3. The invention of claim 1 wherein said malfunction management unit includes a display for indicating whether said monitoring means is enabled.

4. The invention of claim 3 wherein said control signals are assigned to channels; and wherein said display includes a plurality of display units assigned to different channels to indicate those channels for which said monitoring means is enabled.

5. A method of monitoring for conflicts between flashing DON'T WALK pedestrian advisory sign control signals and other control signals used to operate traffic control lights, said method comprising the steps of:
(d) detecting a flashing DON'T WALK pedestrian advisory sign control signal;
(e) detecting the states of the other control signals;
(f) generating a fault signal when a conflict occurs between a flashing DON'T WALK signal and the other control signals.

6. The invention of claim 5 wherein said pedestrian advisory sign control signals and said other control signals are grouped in a plurality of channels; and wherein said method further includes the step of providing a display of those channels on which said steps (a) and (b) are enabled.

7. The invention of claim 5 further including the step of manually enabling the performance of steps (a) and (b).
